(19) United States
(12) Patent Application Publication
(10) Pub. No.: US 2017/0012468 A1
(43) Pub. Date: Jan. 12, 2017

(54) POWER NETWORK MONITORING SYSTEM AND METHOD

(71) Applicant: LSIS CO., LTD., Gyeonggi-do (KR)

(72) Inventor: Kyoung Ho PARK, Gyeonggi-do (KR)

(21) Appl. No.: 15/200,368

(22) Filed: Jul. 1, 2016

(30) Foreign Application Priority Data
Jul. 7, 2015 (KR) 10-2015-0096735

(51) Int. Cl. H02J 13/00; G05B 11/10; G05B 15/02; G05B 11/12; H02J 3/36; G05B 19/042

(52) U.S. Cl. CPC H02J 13/002; H02J 3/36; G05B 19/0428; G05B 15/02; G05B 11/12; G05B 11/10; G05B 2219/1215

(57) ABSTRACT

Power network monitoring systems are presented. In some embodiments, the system includes a master device installed in at least one substation among the plurality of substations, and slave devices installed in remaining substations except from the substation in which the master device is installed. Each of the slave devices may include a first PMU configured to measure data such as reactive/active power, magnitudes and phase angles of a voltage and current of the substation in which the slave device is installed. The master device may analyze data transmitted from each of the slave devices, may generate a command for taking action of a corresponding slave device based on an analyzed result, and may transmit the generated command to the corresponding slave device.

### CROSS-REFERENCE TO RELATED APPLICATIONS

The present application claims the benefit of Korean Patent Application No. 10-2015-0096735, filed on Jul. 7, 2015, which is hereby incorporated by reference in its entirety.

### BACKGROUND

The present disclosure relates to a power network monitoring system capable of monitoring a power network in real time and a method thereof.

According to national economic growth and improvement in people's living standards, convenience of use and power consumption, which is an engine of the national economic growth, continuously increase and an increase in power demand makes a power system complicated, diversified, and having large capacity. However, the 2003 blackout occurring in North America and Europe results from that an initial small scale accident is not rapidly detected and handled to allow power blackout to spread to the entire power system due to weakness of a system for data acquisition and monitoring control for the power system. Accordingly, importance is being magnified for general operation state data acquisition, system analysis, and remote detection control for the power system in an energy management system.

As a prior art for detecting, analyzing, and recording a fault or accident in a power system, Korean Patent Laid-open Publication No. 10-2003-0037499 (published on May 14, 2003, hereinafter citation 1) was proposed.

However, in citation 1, only related data is detected, analyzed, and recorded, and an action corresponding thereto is not taken.

In addition, in citation 1, only a state of a specific substation is figured out and states of various substations connected thereto are not figured out.

### SUMMARY

Embodiments provide a power network monitoring system and method for solving the above and other limitations.

Embodiments also provide a power network monitoring system and method capable of communicating between substations connected to each other.

Embodiments also provide a power network monitoring system and method capable of allowing a substation, in which a master device such as an PMU master is installed, to control a substation, in which a slave device is installed, based on data obtained from a plurality of substations in which a plurality of slave devices such as an PMU slave are respectively installed.

Embodiments also provide a power network monitoring system and method through which a master device and slave devices are installed and operated in an entire power network that includes an alternating current (AC) system and an high-voltage, direct current (HVDC) system linked to the AC system.

In one embodiment, a power network monitoring system that monitors a plurality of substations includes: a master device installed in at least one substation among the plurality of substations; and a plurality of slave devices installed in remaining substations except from the substation in which the master device is installed.

The slave device includes: a first phasor measurement unit (PMU) configured to measure data such as reactive/active power, magnitudes and phase angles of a voltage and current of the substation in which the slave device is installed and a first communication unit configured to transmit data measured by the first PMU to the master device.

The master device analyzes data transmitted from each of the slave devices, generates a command for taking action of a corresponding slave device based on an analyzed result, and transmits the generated command to the corresponding slave device.

In another embodiment, a method of monitoring a power network monitoring system which comprises a master device installed in at least one of a plurality of substations that are connected to each other, and a plurality of slave devices installed in remaining substations except from the substation in which the master device is installed, includes: receiving data from one of the slave devices; checking whether the received data is AC system data; analyzing the received data with reference to an AC system, when the received data is the AC system data; generating a command for taking action of the corresponding slave device based on an analyzed result; and transmitting the generated command to the corresponding slave device.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates a power network monitoring system according to a first embodiment of the present disclosure.

FIG. 2 is a block diagram illustrating a configuration of a slave device according to an embodiment of the present disclosure.

FIG. 3 is a block diagram illustrating a configuration of a master device according to an embodiment of the present disclosure.

FIG. 4 illustrates a power network monitoring system according to a second embodiment of the present disclosure.

FIG. 5 is a flowchart illustrating a monitoring method in a power network monitoring system according to an embodiment of the present disclosure.

### DETAILED DESCRIPTION OF THE EMBODIMENTS

Reference will now be made in detail to the embodiments of the present disclosure, examples of which are illustrated in the accompanying drawings, in which like numbers refer to like elements throughout, and a repetitive explanation will be omitted.

As can be seen from the foregoing, the above-described embodiments is not limited to the configurations and methods of the embodiments described above, but the entirety of or a part of the embodiments may be configured to be selectively combined such that various modifications of the embodiments can be implemented.

In the following description, usage of suffixes such as ‘module’, ‘part’ or ‘unit’ used for referring to elements is given merely to facilitate explanation of the present disclosure, without having any significant meaning by itself. In the following description, detailed descriptions of well-known functions or constructions will be omitted since they would obscure the disclosure in unnecessary detail. In addition, the accompanying drawings are used to help easily understand the technical idea of the present disclosure and it should be understood that the idea of the present disclosure is not limited by the accompanying drawings. This disclosure should not be construed as limited to specific disclosure forms, and the spirit and scope of the disclosure should be understood as incorporating various modifications, equivalents and substitutions.

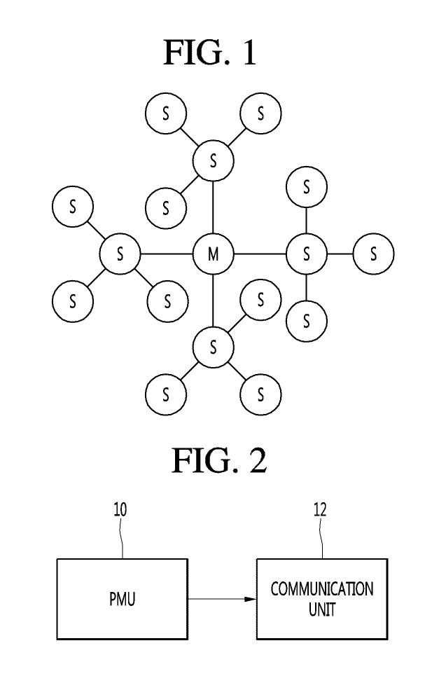

FIG. 1 illustrates a power network monitoring system according to a first embodiment.

As illustrated in FIG. 1, a power network monitoring system according to a first embodiment includes a master device M and a plurality of slave devices S connected to the master device M.

In embodiments, a term “slave” may mean collecting certain data and deliver the collected data, and a term “master” may mean determining and taking action based on data delivered from a slave device S, and delivering commands to the slave device S.

The master device M and the slave device S may be installed, for example, in substations.

The substations may include a 154 kV substation, a 345 kV substation, and a 765 kV substation.

For example, the master device M may be installed in a highest class substation, for example, the 765 kV substation, and the slave device S may be installed in the 154 kV substation or the 345 kV substation, but the embodiment is not limited thereto.

The substation, which is an apparatus for transforming power, namely, a voltage, may transform, for example, a voltage of 345 kV to a voltage of 765 kV, or, for example, transform a voltage of 765 kV to a voltage of 345 kV.

For example, when power is transmitted from a power plant where the power is generated to a demand side, for example, a factory, substations may be installed between the power plant and the factory, wherein the substations include a 154 kV class substation for transforming the power, namely, a voltage of the power plant to 154 kV and transmitting the 154 kV, a 345 kV class substation for transforming the 154 kV to 345 kV and transmitting the 345 kV, a 765 kV class substation for transforming the 345 kV to 765 kV and transmitting the 765 kV, a 345 kV class substation for transforming 765 kV again to 345 kV and transmitting the 345 kV, and a 154 kV class substation for transforming 345 kV again to 154 kV and transmitting the 154 kV.

Data transmission/reception is enabled by using a physical communication cable between the master device M and the slave device S. The slave devices S may transmit data obtained from the substations thereof to the mater device M through the communication cable and the master device M may transmit required actions or commands to the slave device S based on the data received from the slave devices S through the communication cable.

As a data communication scheme of the embodiment, a parallel communication scheme or a serial communication scheme may be used. As the parallel communication scheme, there is an FDD or CD-ROM, etc., and as the serial communication scheme, there is a LAN, RS232, or X.25.

As the data communication of the embodiment, wired communication or wireless communication may be used. As the wireless communication, an RF, Bluetooth, Ethernet, Home PNA, Power line communication (PLC), IEEE1394, Home RF, or wireless LAN, etc., may be used.

In FIG. 1, solid lines connected between the master device M and the slave devices S or between the slave devices S represent communication cables, and through the communication cables, data transmission/reception is enabled between the master device M and the slave devices S.

Activation function for a data transmission/reception is set in advance to enable data transmission/reception between the master device M and each slave device S or a deactivation function for a data transmission/reception may be set not to enable data transmission and reception. Through such a setting, in certain cases, namely, in a case where the activation function is set, data transmission and reception is enabled between a specific slave device S and the master device M. However, in another case where the deactivation function is set, data transmission/reception may not be enabled between the specific slave device S and the master device M. Accordingly, the master device M may adjust the number of slave devices S which are managed by the master device M, namely, through which data transmission/reception is enabled.

In FIG. 1, one master device M is illustrated but the number of master devices M may be two or more, and is not limited thereto.

FIG. 2 is a block diagram illustrating a configuration of a slave device.

Referring to FIG. 2, the slave device S may include a phasor measurement unit (PMU) 10 and a communication unit 12.

The PMU 10 may measure data such as reactive/active power, magnitudes and phase angles of a voltage and current, at one or more points in a substation in which the slave devices S are installed. Accordingly, at least one PMU 10 may be installed in the substation in which the slave device S is installed.

The communication unit 12 may transmit data measured by at least one PMU 10 to the master device M by using a communication cable. In addition, the communication unit 12 may receive data, for example, a command or a control signal, from the master device M. In this case, a slave device S or a substation in which the slave device S is installed may perform a specific function, for example, line blocking.

On the other hand, the data obtained by the PMU 10 may be synchronized. In other words, the data obtained by the PMU 10 may be synchronized with a common time of a GPS wireless clock. Data obtained by each PMU 10 of the slave device S installed in each substation may be synchronized with the common time of the GPS wireless clock.

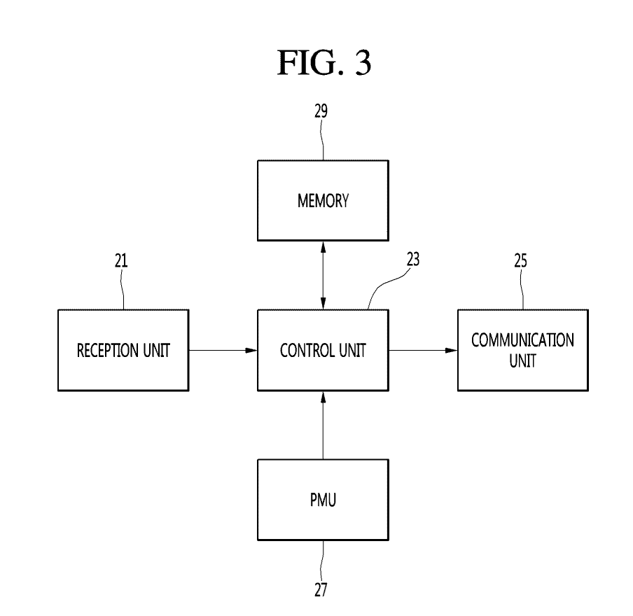

FIG. 3 is a block diagram illustrating a configuration of a master device.

Referring to FIG. 3, the master device M includes a reception unit 21, a control unit 23, a communication unit 25, a memory 29, and a PMU 27.

The PMU 27 may measure data such as reactive/active power, magnitudes and phase angles of a voltage and current at one or more points in a substation in which the master device M is installed. Accordingly, at least one PMU 27 is installed in the substation in which the master device M is installed.

The memory 29 may store the determined result or the analyzed result from the control unit 23 and store setting data set in the master device M. The setting data may include, for example, the number of or identification information on the slave devices S capable of receiving related data, but is not limited thereto. The determination result may be, but is not limited to, power blackout related information, fault related information, a state of or situation information on a substation in which the slave device S is installed, or a load state of or situation information on another substation connected to the substation.

Such a determination result may be stored in the memory 29 temporarily or in real time to be used later as back data at the time of occurrence of power network blackout.

The reception unit 21 may receive data transmitted from the slave device S. Here, the data may be reactive/active power, magnitudes and phase angles of a voltage and current.

The communication unit 25 may transmit data to the slave device S. Here, the data may be a command or a control signal, but is not limited thereto. The slave device S may perform a specific function, for example, line blocking in response to the command or control signal.

For example, when a power blackout accident occurs in a factory connected to the substation in which the slave device S is installed, data to which the power blackout accident is reflected by the slave device S may be measured and transmitted to the master device M. The master device M may figure out the power blackout accident of the factory through the data to which the power blackout accident is reflected and then transmit a command on line blocking to the slave device S. Accordingly, the substation in which the slave device S is installed may control such that a line installed between the slave device S and the factory is blocked according to the command.

The control unit 23 may figure out a state or situation of the substation, in which a slave device S is installed, based on data received through the reception unit 21 from the corresponding slave device S, or a state or situation of another substation or a load connected to the substation, and may generate a command or control signal and transmit the command or control signal to the slave device S through the communication unit 25 in order to take a necessary action based on the figured out state or situation.

According to an embodiment, a power network monitoring system is divided into a slave device and a master device M, and data measured by the slave device S is transmitted to the master device M. The master device M controls such that a necessary action is taken to a substation, in which the slave device S is installed, based on data measured by the slave device S. Accordingly a cascading phenomenon caused by a power blackout or fault accident may be prevented beforehand.

According to an embodiment, since related data is measurable at the slave device S in real time, accident is prevented in real time to enable efficient power network management.

On the other hand, a power network monitoring system of an embodiment may be applied to not only an AC system but also an HVDC system or a linked network of the AC system and HVDC system.

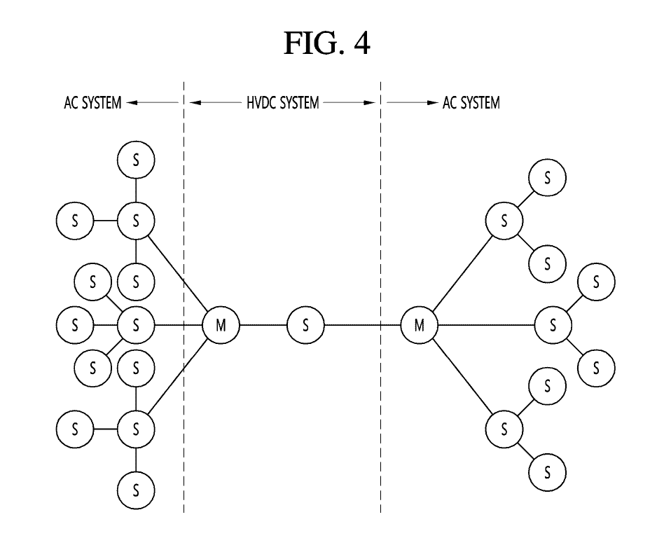

A power network monitoring system at the time of linking the AC system and HVDC system is illustrated in FIG. 4.

FIG. 4 illustrates a power network monitoring system according to a second embodiment.

Referring to FIG. 4, a power network monitoring system according to a second embodiment includes a master device M and a plurality of slave devices S connected to the master device M.

The master device M may be installed in a direct current (DC) transmission substation of the HVDC system and the slave device S may be installed in a substation of the AC system.

Alternatively, the master device M is installed in a substation of the AC system and the slave device S is installed in a DC transmission substation of the HVDC system, but the embodiment is not limited thereto.

The DC transmission substation of the HVDC system may be connected to the substation of the AC system. In this case, the DC transmission substation of the HVDC system may convert AC power provided from the substation of the AC system, namely, an AC voltage into a DC voltage. When the AC voltage provided from the substation of the AC system is a 345 kV AC voltage, the DC transmission substation may transform the 345 kV AC voltage to a 765 kV DC voltage.

In detail, when the AC voltage provided from the substation of the AC system is a 345 kV AC voltage, the DC transmission substation may transform the 345 kV AC voltage to a 765 kV AC voltage and then convert the 765 kV AC voltage to a 765 kV DC voltage.

Alternatively, the 345 kV AC voltage may be firstly converted to a 345 kV DC voltage and then the 345 kV DC voltage may be transformed to a 765 kV DC voltage, but the embodiment is not limited thereto.

The DC transmission substation may include one of a 154 kV substation, a 345 kV substation, and a 765 kV substation, but in view of minimization of power loss, the DC transmission substation may preferably include the 765 kV substation.

For example, the DC transmission substation in which the master device M is installed may be a highest class substation, for example, a 765 kV DC transmission substation, and the substation in which the slave device S is installed may be a 154 kV substation or a 345 kV substation, but the embodiment is not limited thereto.

As illustrated in FIG. 4, the DC transmission substation in which the master device M is installed may be an HVDC system that converts an AC voltage to a DC voltage and transmits the DC voltage, and the substation in which the slave device S is installed may be an AC system that transforms an AC voltage.

In the HVDC system, the DC transmission substation connected to the substation in which the slave device S is installed may be a transmission side DC transmission substation, and another DC transmission substation connected to the transmission side DC transmission substation may be a demand side DC transmission substation.

A slave device S may be installed in the demand side DC transmission substation, but the embodiment is not limited thereto. The slave device S installed in the demand side DC transmission substation may also transmit data measured by the demand side DC transmission substation to a master device M installed in the transmission side DC transmission substation.

The demand side DC transmission substation may convert a 765 kV DC voltage to a 765 kV AC voltage and then transform the 765 kV AC voltage to a 345 kV AC voltage or a 154 kV AC voltage.

The AC system substation provided with a master device M is connected to the demand side DC transmission substation provided with a slave device S, and at least one AC system substation may be connected to the AC system substation. In this case, a slave device S may be installed in each of at least one AC system substation, but the embodiment is not limited thereto.

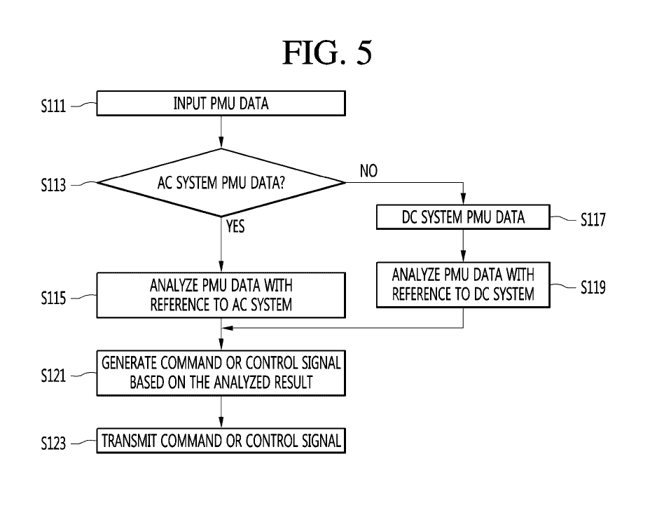

FIG. 5 is a flowchart illustrating a monitoring method in a power network monitoring system according to an embodiment.

FIG. 5 illustrates an operation method in a master device.

Referring to FIGS. 1 to 5, PMU data transmitted from a plurality of slave devices S is input (operation S111).

Here, the PMU data may mean data measured by the PMU 10 of the slave device S.

The PMU data may include reactive/active power, magnitudes and phase angles of a voltage and current.

The control unit 23 of the master device M checks whether the PMU data is AC system PMU data or HVDC system PMU data (operation S113).

The PMU data may be differed according to an AC system and HVDC system. For example, the AC system PMU data may be reactive/active power, a voltage, and a current in a sinusoidal wave type. For example, the HDVC system PMU data may be reactive/active power, a voltage, and a current at a constant level.

When the PMU data is AC system PMU data, the control unit 23 analyzes the PMU data with reference to the AC system.

Since the AC system PMU data is different from the HVDC system PMU data, it is necessary to analyze the PMU data with references respectively proper thereto.

For the AC system PMU data, a rate that a waveform of a sinusoidal wave varies may be used as a reference for analyzing AC system PMU data. Accordingly, the AC system PMU data may be analyzed based on the rate that the waveform of the sinusoidal wave varies.

For example, when the rate that the waveform of a sinusoidal wave of the AC system PMU data varies exceeds a first rate set as a reference value, it may be considered that a fault occurs in a substation in which a slave device S, which transmits the AC system PMU data, is installed.

For example, when the rate that the waveform of a sinusoidal wave of the AC system PMU data varies exceeds a second rate greater than the first rate, it may be considered that a power blackout occurs in a substation in which a slave device S, which transmits the AC system PMU data, is installed.

When the PMU data is not the AC system PMU data, the PMU data may be HDVC system PMU data (operation S117).

In this case, the control unit 23 analyzes the PMU data with reference to the HVDC system (operation S119).

For the HVDC system PMU data, an offset value may be a reference for analyzing the HVDC system PMU data. Accordingly, the HVDC system PMU data may be analyzed according to a degree that exceeds each of a plurality of offset values.

For example, when a certain level of a DC component of the HVDC system PMU data exceeds a first offset value set as a reference value, it may be considered that a fault occurs in a DC transmission substation in which a slave device S, which transmits the HVDC system PMU data, is installed.

For example, when the certain level of the DC component of the HVDC system PMU data exceeds a second offset value greater than the first offset value, it may be considered that a power blackout occurs in the DC transmission substation in which the slave device S, which transmits the HVDC system PMU data, is installed.

The control unit 23 generates a command or control signal based on the analyzed result (operation S121), and controls such that the generated command or control signal is transmitted to the substation in which the corresponding slave device S is installed through the communication unit 24 (operation S123).

Thereafter, the substation in which the corresponding slave device S is installed may take an action corresponding to a command or controls signal provided from the master device M. For example, such an action may block lines between a substation and a load in which a power blackout occurs among other substations or loads connected to the corresponding substation and inform a user of the fault or power blackout through the monitor.

According to at least one embodiment, a cascading phenomenon due to a power blackout or fault accident may be prevented in advance by dividing a power network monitoring system into a slave device and a master device and sending data measured by the slave device to the master device so that the master device controls necessary actions to be taken to a substation in which the slave device is installed based on the data measured by the slave device.

In addition, according to at least one embodiment, since the slave device may measure related data in real time, an accident prevention may be performed in real time to enable a power network to be efficiently managed.

According to embodiments, a master device and a slave device are installed in a corresponding power plant, even when an AC system is linked to an HVDC system. Accordingly, power network management is enabled not only for the AC system but also for the HVDC system by the master device, and integrated management for the power network is enabled.

An additional scope of applicability of the present disclosure shall become obvious from the detailed description in the following. However, it should be understood that the detailed description and specific examples, while indicating preferred embodiments of the present disclosure, are given by way of illustration only, since various changes and modifications within the spirit and scope of the present disclosure will become apparent to those skilled in the art from the detailed description.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. Various components illustrated in the figures may be implemented as hardware and/or software and/or firmware on a processor, ASIC/FPGA, dedicated hardware, and/or logic circuitry. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A power network monitoring system that monitors a plurality of substations, the power network monitoring system comprising:
a master device configured to be installed in at least one substation among a plurality of substations; and
a plurality of slave devices configured to be installed in the plurality of substations except from the substation in which the master device is installed,
wherein each of the slave devices comprises:
a first phasor measurement unit (PMU) configured to measure data of the substation in which the slave device is installed; and
a first communication unit configured to transmit the data measured by the first PMU to the master device,
wherein the master device is configured to analyze the data transmitted from each of the slave devices, generate a command for taking action of a corresponding slave device based on the analyzed data, and transmit the generated command to the corresponding slave device.

2. The power network monitoring system according to claim 1, wherein the data or command is transmitted and/or received between the master device and the corresponding slave device by using at least one of: a communication cable or a wireless communication.

3. The power network monitoring system according to claim 1, wherein the substation comprises:
one of a 154 kV class substation, a 345 kV class substation, or a 765 kV class substation, and
the master device is configured to be installed at least in the 765 kV class substation.

4. The power network monitoring system according to claim 3, wherein the slave device is configured to be installed in the 345 kV class substation or the 765 kV class substation.

5. The power network monitoring system according to claim 1, wherein the substations comprise a DC transmission substation configured to enable DC conversion and transmission and a plurality of AC system substations connected to the DC transmission sub station.

6. The power network monitoring system according to claim 5, wherein the DC transmission substation comprises an HVDC system DC transmission substation.

7. The power network monitoring system according to claim 5, wherein the master device is configured to be installed in the DC transmission substation and the slave device is configured to be installed in the AC system substation.

8. The power network monitoring system according to claim 5, wherein the master device is configured to be installed in the AC system substation and the slave device is configured to be installed in the DC transmission substation.

9. The power network monitoring system according to claim 1, wherein the master device comprises:
a reception unit configured to receive the data transmitted from the slave device;
a control unit configured to analyze the data received from the reception unit and to generate a command for taking action of the corresponding slave device; and
a second communication unit configured to transmit the command generated from the control unit to the corresponding slave device.

10. The power network monitoring system according to claim 9, wherein the master device comprises:
a second PMU configured to measure data of the substation in which the master device is configured to be installed; and
a memory configured to store the analyzed data from the control unit and store setting data set in the master device.

11. The power network monitoring system according to claim 10, wherein the setting data comprises a number of data-receivable slave devices and identification information on the data-receivable slave devices.

12. The power network monitoring system according to claim 1, wherein an activation function or a deactivation function that indicates whether data transmission and/or reception is enabled is set between the master device and the slave device.

13. The power network monitoring system according to claim 1, wherein the measured data is synchronized with a common time of a GPS wireless clock.

14. A method of monitoring a power network monitoring system which comprises a master device configured to be installed in at least one of a plurality of substations that are connected to each other, and a plurality of slave devices configured to be installed in remaining substations except from the substation in which the master device is installed, the method comprising:
receiving data from one of a plurality of slave devices;
checking whether the received data is AC system data;
analyzing the received data with reference to an AC system, when the received data is the AC system data;
generating a command for taking an action of a corresponding slave device based on the analyzed data; and
transmitting the generated command to the corresponding slave device.

15. The method according to claim 14, wherein the reference to the AC system is set as a rate that a waveform of the data varies.

16. The method according to claim 15, wherein analyzing the received data comprises:
determining that the substation in which the slave device is installed is faulty when the rate that a data waveform varies exceeds a first rate; and
determining that the substation in which the slave device is installed is in power blackout when the rate that the data waveform varies exceeds a second rate greater than the first rate.

17. The method according to claim 14, further comprising:
checking whether the received data is high-voltage, direct current (HVDC) system data; and
analyzing the received data with reference to an HVDC system, when the received data is the HVDC system data.

18. The method according to claim 17, wherein the reference to the HVDC system is set to an offset value.

19. The method according to claim 17, wherein analyzing the received data with reference to an HVDC system comprises:
determining that the substation in which the slave device is installed is faulty, when a certain level of a DC component of the received data exceeds a first offset value; and
determining that the substation in which the slave device is installed is in power blackout, when the certain level of the DC component of the received data exceeds a second offset value.
